(19) United States
(12) Patent Application Publication
(10) Pub. No.: US 2026/0340604 A1
(43) Pub. Date: Oct. 29, 2026

(54) ENABLING IN-PERSON ACCOUNT-TO-ACCOUNT TRANSACTIONS

(71) Applicants: American Express Travel Related Services Company, Inc., New York, NY (US); American Express Services Europe Limited, London (GB)

(72) Inventors: Dhanya Prasannakumari Govinda Pillai, Burgess Hill (GB); Manik Biswas, Burgess Hill (GB); Mukund Shankar SimhaRaghu, Glendale, AZ (US)

(21) Appl. No.: 19/188,536

(22) Filed: Apr. 24, 2025

(51) Int. Cl. G06Q 20/10; G06Q 20/32; G06Q 20/40

(52) U.S. Cl. CPC G06Q 20/10; G06Q 20/326; G06Q 20/40

(57) ABSTRACT

Disclosed are various embodiments for enabling in-person account-to-account transactions using a computing device. The computing device can receive a payment request from a payment terminal, send a request for payment method to a user interface, and receive a selection of a payment method via the user interface, where the payment method is a transfer from an account. The computing device can generate a payment instruction based at least in part on the selection of the payment method and send the payment instruction to an institution application associated with the account. Next, the computing device can receive a payment authorization from the institution application.

### BACKGROUND

When making in-store purchases, a customer may have limited options for payment. These options can be limited by the payment instruments held by the customer or by the capabilities of the merchant. In many circumstances, a customer may wish to pay for a transaction at a merchant using a transaction account. However, current rails with point-of-sale (POS) transactions do not support account-to-account transactions.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIGS. 2-4 are pictorial diagrams of example user interfaces rendered by a client device according to various embodiments of the present disclosure.

FIG. 5 is a drawing of a network environment according to various embodiments of the present disclosure.

FIG. 6 is a flowchart illustrating one example of functionality implemented as portions of an application executed in a computing environment in the network environment of FIG. 5 according to various embodiments of the present disclosure.

FIG. 7 is a sequence diagram illustrating one example of interactions between components in the network environment of FIG. 5 according to various embodiments of the present disclosure.

### DETAILED DESCRIPTION

Disclosed are various approaches for enabling in-person account-to-account transactions. Account-to-account transactions are direct payments made between two accounts without the use of intermediaries, such as credit card networks or other payment networks. While direct account-to-account payments have reduced complexity in that there are fewer intermediaries, there is also a greater security risk which comes with direct access to an account. Thus, many account-to-account payments require a user to complete a login and authentication process before the transaction will be processed. Additionally, some processes for account-to-account transactions utilize application programming interface (API) calls between software applications in order to complete the process.

Initiation of an account-to-account transfer typically requires a user to know and provide their account information, such as an account number and/or routing number, and verify their identity with their financial institution. Thus, at a typical in-person transaction with a point of sale (POS) machine, it is both impractical and technologically unsupported to perform an account-to-account transaction. Accordingly, various embodiments of the present disclosure relate to enabling mobile devices to conduct POS account-to-account transactions. By enabling a mobile device to initiate or perform these transactions, the time and complexity of an in-person account-to-account transaction is reduced by limiting the number of platforms which are required. This can consolidate the payment process from into a seamless transaction. Rather than having to add steps and technology to an in-person transaction to facilitate an online entry of account information and identity verification, the present invention leverages short-range communications and online open banking rails to allow users to seamlessly conduct an in-person account-to-account transfer.

For example, in a typical payment with mobile device, the payment information is stored on the mobile device and provided to a POS machine using a secure communications protocol. For example, a mobile device could provide stored credit or debit card information to a PoS machine using a short range, wireless communication protocol, such as a near-field communication (NFC) connection. The PoS machine could then submit the credit or debit card information to a payment processing network (e.g., VISA®, MASTERCARD®, AMERICAN EXPRESS®, etc.) to authorize payment for the transaction. Once the transaction is authorized, the PoS machine can return a message to the mobile device indicating that the payment has been successfully processed. As another example, a mobile device could provide stored bank account information (e.g., for a checking account or other demand deposit account (DDA)), to the PoS machine. The PoS machine could then submit the bank account information to an electronic funds transfer point of sale (EFTPOS) network (e.g., PULSE®, NYCE®, MAC®, TYME®, SHAZAM®, STAR®, etc.) to authorize payment for the transaction. Once the transaction is authorized, the PoS machine can return a message to the mobile device indicating that the payment has been successfully processed.

In contrast, various embodiments of the present disclosure allow for a user to make a payment using his or her demand deposit account (DDA) without having to have information for the DDA stored on his or her mobile device. For example, a user can select to make a payment using his or her DDA. The user's mobile device can then contact the financial institution that maintains his or her DDA using one or more application programming interface (API) calls to retrieve the account information and/or authorize payment to the merchant. These API calls are often referred to as open banking rails, online open banking rails, open banking payment rails, etc. For example, the user's mobile device could retrieve account information for his or her DDA from the financial institution and provide it to the PoS machine, which could submit the account information for the DDA to an EFTPOS network. As another example, the user's mobile device could authorize payment from the DDA to the merchant. The merchant's PoS could then receive a confirmation of payment and provide a corresponding approval message to the mobile device of the user.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

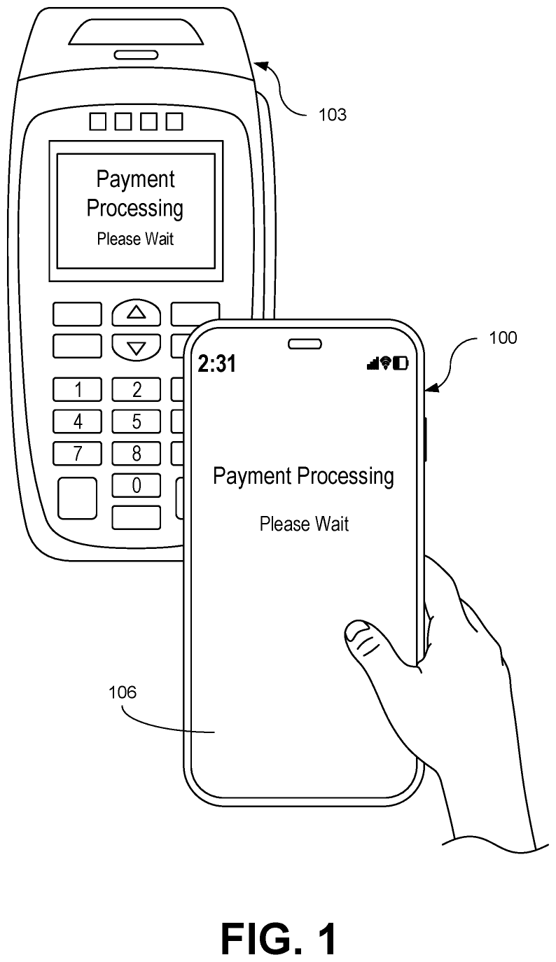

As illustrated in FIG. 1, shown is an example of a client device 100 interacting with a payment terminal 103. In some examples, the client device 100 and the payment terminal 103 can communicate via a short-range wireless connection in order to complete various tasks. For example, as shown by the user interface 106 of the client device 100, the client device 100 and the payment terminal 103 can communicate in order to process a transaction or a payment for a transaction. The short-range wireless connection can be a near-field communication (NFC) connection, a Bluetooth® connection, an ultrawideband connection, a WiFi connection, or other form of short-range wireless connection. The communication can comprise an exchange of encrypted data over the short-range wireless connection in order to exchange payment information as well as identity information.

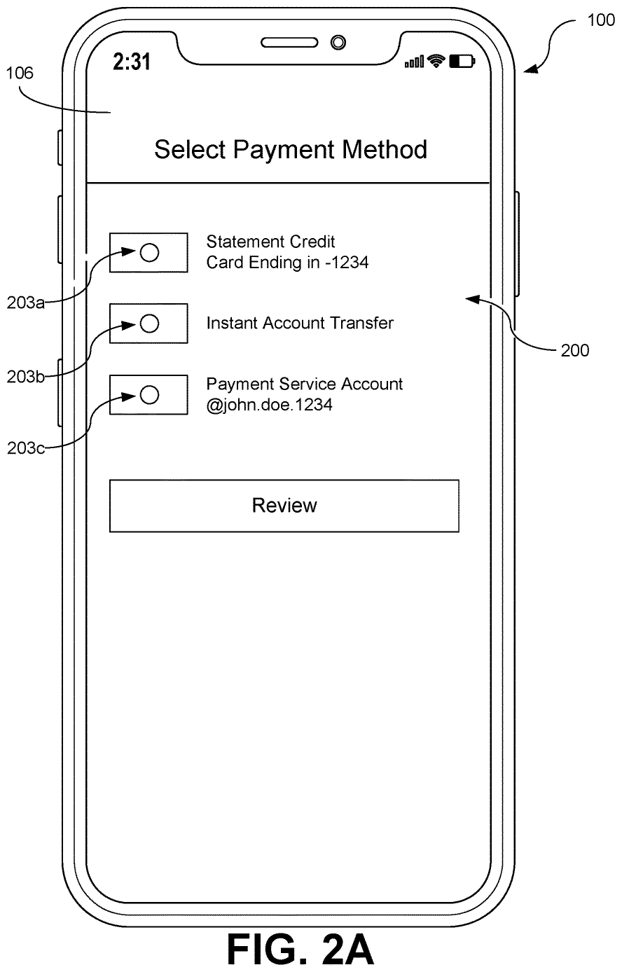

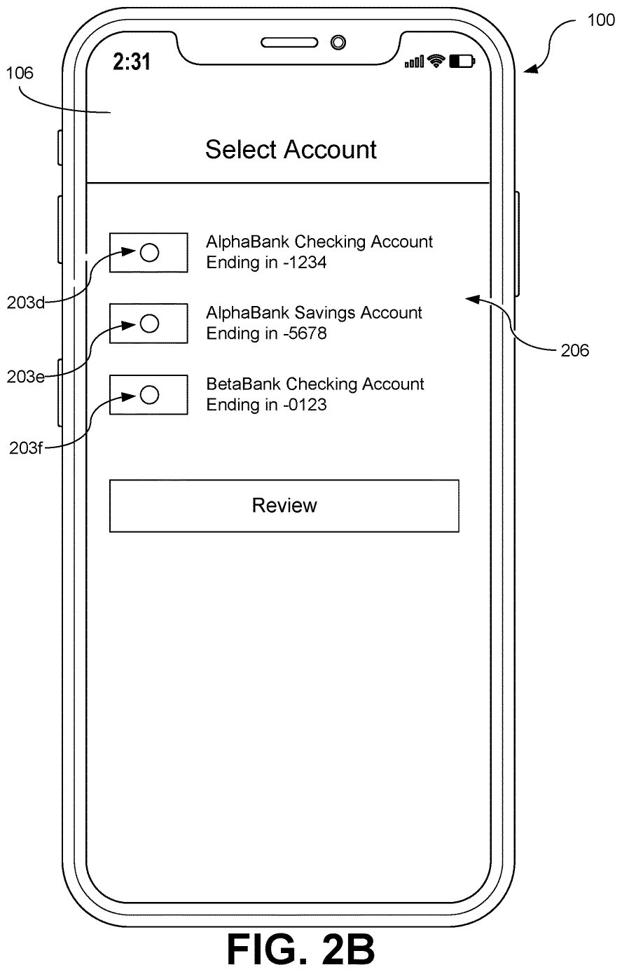

Next, in FIG. 2A, shown is a user interface 106 on the client device 100 according to various embodiments. The client device 100 can present one or more payment methods 200 in the user interface 106. The user interface 106 of FIG. 2A can be triggered by an interaction with the payment terminal 103 of FIG. 1. In some examples, a user can engage in a short-range wireless communication with a payment terminal 103 and receive merchant and/or transaction data from the payment terminal 103. In response to receipt of this data, the client device 100 can present the user with one or more payment methods 200 to complete the transaction. The user interface 106 can include one or more user interface elements 203 with which the user can interact. As shown in FIG. 2A, the user interface elements 203 can correspond to the various payment methods 200. For example, user interface element 203a can correspond to a credit card, user interface element 203b can correspond to an instant account transfer from a demand deposit account (e.g., a checking account, savings account, money market account, or other transaction account where deposits and withdrawals can be made on-demand by the owner of the account), and user interface element 203c can correspond to a payment service account. The user can interact with a user interface element 203 in order to select a payment method 200.

At FIG. 2B, shown is another user interface 106 on the client device 100 according to various embodiments of the present invention. The user interface of FIG. 2B can be presented on the client device 100 in response to a user selecting user interface element 203b from FIG. 2A. After selecting to pay with an instant account transfer, the user can be directed to the user interface 106 of FIG. 2B where they can select an account. In some examples, the user interface 106 can present a list of different accounts 206 associated with different financial institutions, where each account has a corresponding user interface element 200. For example, as shown in FIG. 2B, the user interface 106 can present a user interface element 203d which corresponds to a checking account for AlphaBank, a user interface element 203e corresponding to a savings account for AlphaBank, a user interface element 203f corresponding to a checking account for BetaBank, and potentially other user interface elements 203. In some examples, the user interface 106 presents a list of financial institutions for the user to choose from, and the presents accounts 206 associated with those institutions.

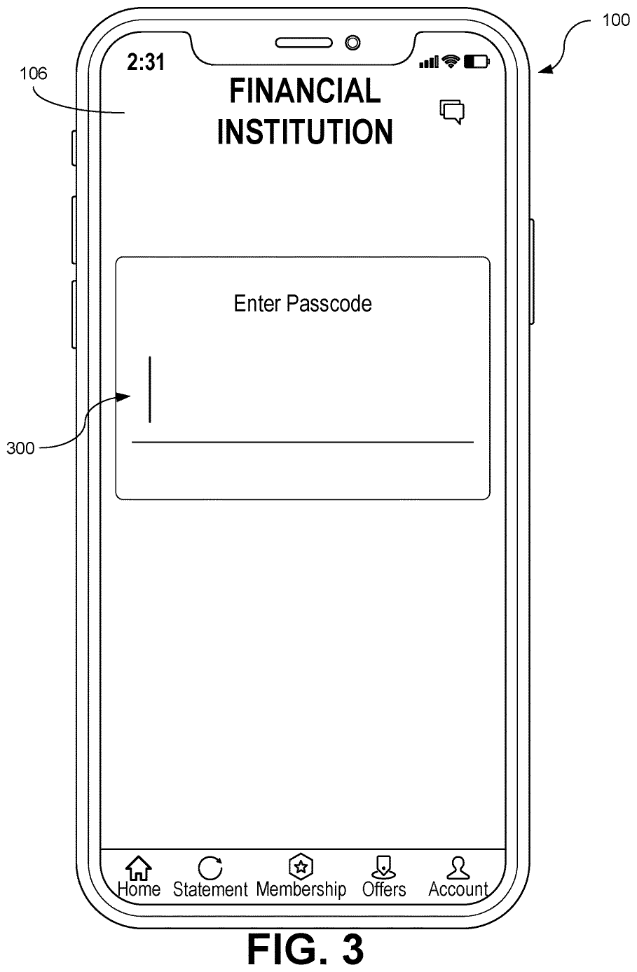

Moving to FIG. 3, shown is a user interface 106 on the client device 100 according to various embodiments. The user can reach the user interface 106 of FIG. 3 by selecting the user interface element 203b for a demand deposit account associated with a financial institution (e.g., financial institution, brokerage, etc.). The user interface 106 of FIG. 3 can be representative of an application of the financial institution associated with the demand deposit account. In some examples, when the user selects the demand deposit account with user interface element 203b, the client device 100 can redirect the user to an application of the financial institution to complete an authentication. As shown in FIG. 3, the authentication can comprise a user interface element 300 where a user can enter a passcode. However, authentication can be performed using a password, personal identification number (PIN), pattern, biometric authentication, or other form of authentication.

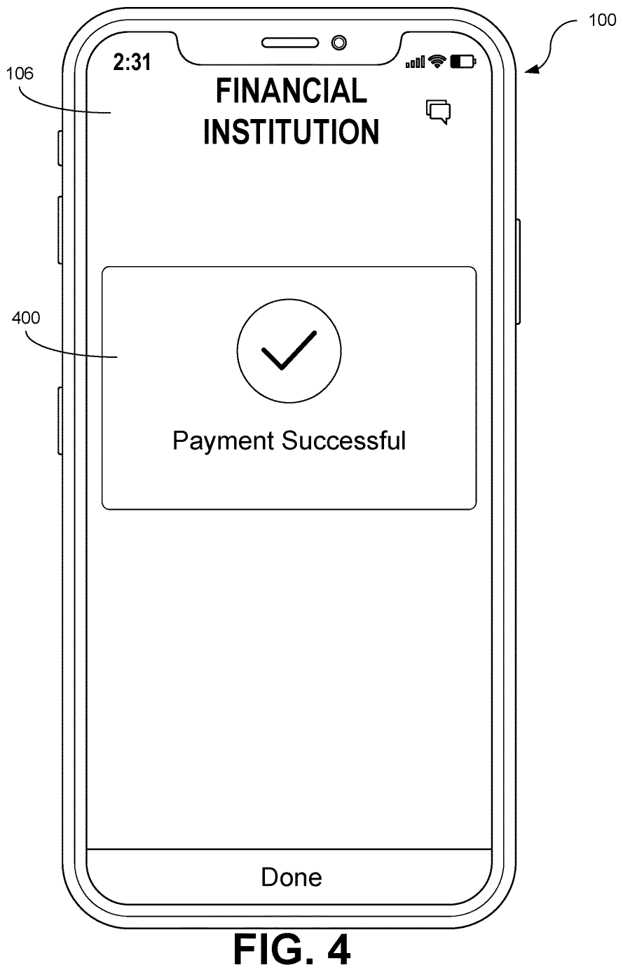

Next, in FIG. 4, a user interface 106 is shown on a client device 100 according to various embodiments. The user interface 106 can contain a message or notification 400 indicating that an account-to-account payment was successful. The message or notification 400 can be presented in the user interface 106 in response to having completed the authentication of FIG. 3 successfully and the financial institution successfully completing the transfer of funds. In some examples, the message or notification 400 can include information about the transaction such as the total amount of the transaction, the account used for payment, the merchant with whom the transaction was made, as well as other information.

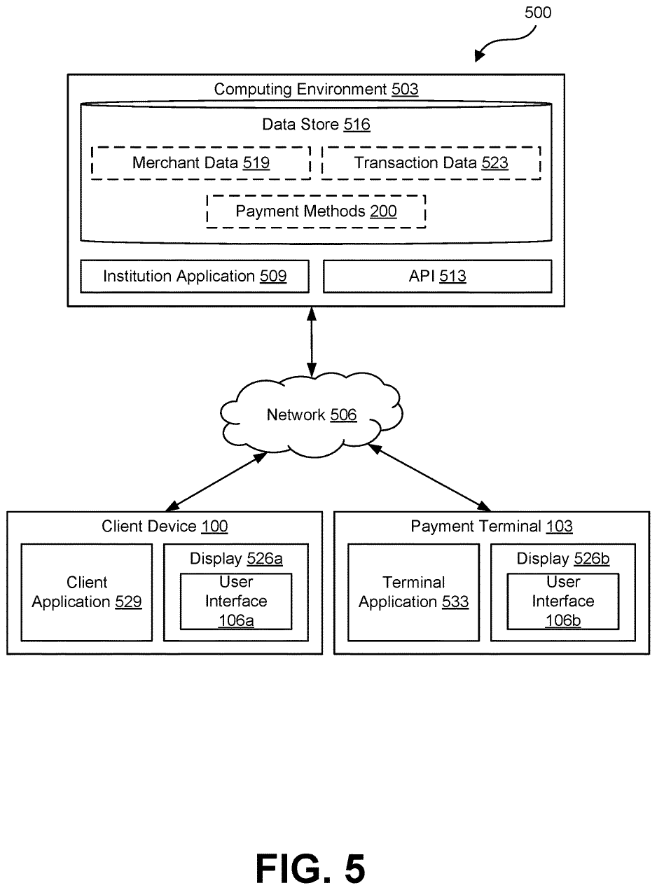

Moving to FIG. 5, shown is a network environment 500 according to various embodiments. The network environment 500 can include a computing environment 503, a client device 100, and a payment terminal 103, which can be in data communication with each other via a network 506.

The network 506 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 506 can also include a combination of two or more networks 506. Examples of networks 506 can include the Internet, intranets, extranets, virtual private networks (VPNs), and similar networks.

The computing environment 503 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 503 can employ a plurality of computing devices that can be arranged in one or more server financial institutions or computer financial institutions or other arrangements. Such computing devices can be located in a single installation or can be distributed among many different geographical locations. For example, the computing environment 503 can include a plurality of computing devices that together can include a hosted computing resource, a grid computing resource or any other distributed computing arrangement. In some cases, the computing environment 503 can correspond to an elastic computing resource where the allotted capacity of processing, network, storage, or other computing-related resources can vary over time.

Various applications or other functionality can be executed in the computing environment 503. The components executed on the computing environment 503 include an institution application 509, an application programming interface (API) 513, and other applications, services, processes, systems, engines, or functionality not discussed in detail herein.

The institution application 509 can be executed to receive requests to transfer funds from an account held with the institution. The institution application 509 can perform authentication of a user in response to receiving such a request. In addition, once the user has been authenticated and the request has been approved, the institution application 509 can process the request and transfer funds from the user's account to a merchant account. The institution application 509 can be hosted by the institution with which the account is associated (e.g., a financial institution, etc.). For example, if a user has a demand deposit account with their financial institution, the financial institution can host the institution application 509 and complete the transfer of funds from the demand deposit account using the financial institution's payment rails.

The application programming interface (API) 513 can serve as a communication interface for facilitating the sending and receiving of data between the various applications, service, processes, and systems within the network environment 500. The API 513 can be representative of one or more APIs 513 used to facilitate communications in the network environment. In some examples, the API(s) 513 are used to allow requests and responses for payment, transfer, authentication, etc. to be traded between applications.

Also, various data is stored in a data store 516 that is accessible to the computing environment 503. The data store 516 can be representative of a plurality of data stores 516, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 516 is associated with the operation of the various applications or functional entities described below. This data can include merchant data 519, transaction data 523, payment methods 200, and potentially other data.

The merchant data 519 can represent various data about the merchant associated with the payment terminal 103. The merchant data 519 can include information about the type of merchant (e.g., retail, service, travel, etc.), the merchant location, a merchant identifier (e.g., store number, etc.), as well as other information. Merchant data 519 can be transferred from the payment terminal 103 during a transaction. In some examples, merchant data 519 includes merchant account information for receiving an account-to-account transfer.

The transaction data 523 can represent information about a transaction between a user or client and the merchant. In some examples, transaction data 523 can include a transaction time, date, amount, merchant identifier, a transaction identifier, or other information about a transaction. In some examples, the transaction data 523 can be transferred from the payment terminal 103 during a transaction.

The payment methods 200 can be representative of a variety of options which can be used to pay for a transaction. For example, a payment method 200 can represent a payment card (e.g., debit or credit card, rewards card, etc.), a transaction account (e.g., demand deposit account, savings account, reward points account, etc.), payment service account (e.g., PayPal®, Venmo®, Cash App®, etc.), digital wallet, or other form of payment. Each payment method 200 can have associated account data such as account numbers, balances, associated financial institution information, transaction history, etc.

The client device 100 is representative of a plurality of client devices that can be coupled to the network 506. The client device 100 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 100 can include one or more displays 526a, such as liquid crystal displays (LCDs), gas plasma-based flat panel displays, organic light emitting diode (OLED) displays, electrophoretic ink (“E-ink”) displays, projectors, or other types of display devices. In some instances, the display 526a can be a component of the client device 100 or can be connected to the client device 100 through a wired or wireless connection.

The client device 100 can be configured to execute various applications such as a client application 529 or other applications. The client application 529 can be executed in a client device 100 to access network content served up by the computing environment 503 or other servers, thereby rendering a user interface 106a on the display 526a. To this end, the client application 529 can include a browser, a dedicated application, or other executable, and the user interface 106a can include a network page, an application screen, or other user mechanism for obtaining user input.

The client application 529 can also be configured to perform a payment process, such as the example process illustrated in FIGS. 1-4. For example, the client application 529 can receive merchant data 519 and transaction data 523 from a payment terminal 103 and present the payment methods 200 to the user via the user interface 106a of the display 526a. The client application 529 can receive a selection of a payment method 200 via the user interface 106a and in response, contact the institution application 509 via one or more API(s) 513. In some examples, the client application 529 can authenticate a user and send payment instructions to the institution application 509 to complete a payment for a transaction. The client device 100 can be configured to execute applications beyond the client application 529 such as email applications, social networking applications, word processors, spreadsheets, or other applications.

The payment terminal 103 is representative of a plurality of payment terminals that can be coupled to the network 506. The payment terminal 103 can include a processor-based system such as a computer system. Such a computer system can be embodied in the form of a designated point-of-sale (POS) machine, a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), or other devices with like capability. The payment terminal 103 can include one or more displays 526b, such as liquid crystal displays (LCDs), gas plasma-based flat panel displays, organic light emitting diode (OLED) displays, electrophoretic ink (“E-ink”) displays, projectors, or other types of display devices. In some instances, the display 526b can be a component of the payment terminal 103 or can be connected to the payment terminal 103 through a wired or wireless connection.

The payment terminal 103 can be configured to execute various applications such as a terminal application 533 or other applications. The terminal application 533 can be executed in the payment terminal 103 to access network content served up by the computing environment 503 or other servers, thereby rendering a user interface 106b on the display 526b. The terminal application 533 can be executed to establish a connection with the client application 529 and exchanged merchant data 519, transaction data 523 and payment information.

Next, a general description of the operation of the various components of the network environment 500 is provided. Although the following description provides one illustrative example of the operations of and interactions between the various components of the network environment 500, other operations and interactions are also encompassed by the various embodiments of the present disclosure. More detailed discussion of the operations of individual components is provided in the discussion accompanying the subsequent drawings.

To begin, a user and a merchant can engage in an exchange or transaction. For the user to pay for the transaction, the user can use their client device 100 to establish a short-range wireless connection with the payment terminal 103 of the merchant. Once this connection is established, the terminal application 533 can send various data, such as merchant data 519 and transaction data 523 to the client application 529 on the client device 100. In response to receiving this data from the payment terminal 103, the client application 529 can retrieve one or more payment methods 200 which are supported on the client device 100, including an option for an account-to-account transfer, and present the options to the user via the user interface 106a. The user can select a payment method 200 via an interaction with the user interface 106a. When the user selects the option to conduct an account-to-account transfer, the client application 529 can be executed to utilize one or more API(s) 513 to communicate with the institution application 509 associated with the user's account.

Next, the institution application 509 can communicate with the client application 529 to conduct a user authentication. In some examples, the institution application 509 and the client application 529 can also be executed to perform a confirmation of the request to perform the account-to-account transfer. Once the user and request have been verified, the institution application 509 can process the transaction and transfer funds from the user account to the merchant account. Upon a successfully transfer, a notification can be shared with the client device 100 and the payment terminal 103 to alert the user and the merchant that the purchase was successful.

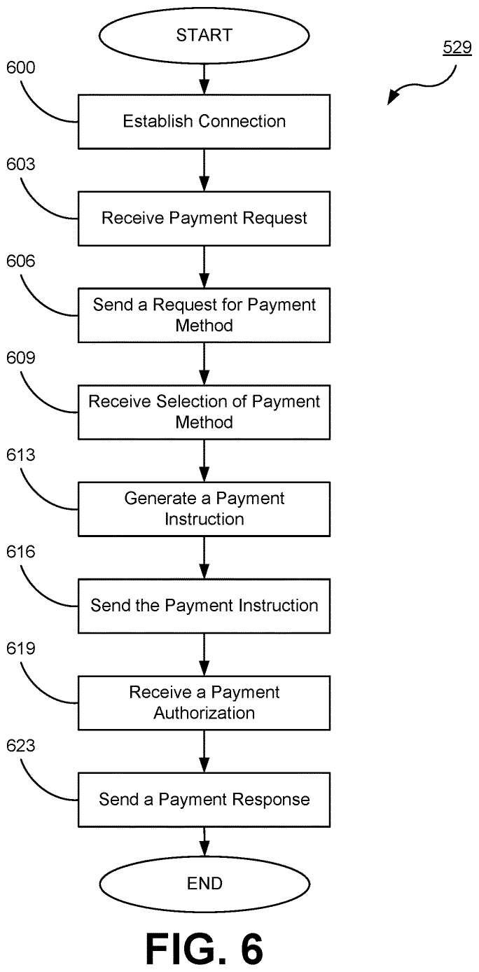

Referring next to FIG. 6, shown is a flowchart that provides one example of the operation of a portion of the client application 529. The flowchart of FIG. 6 provides merely an example of the many different types of functional arrangements that can be employed to implement the operation of the depicted portion of the client application 529. As an alternative, the flowchart of FIG. 6 can be viewed as depicting an example of elements of a method implemented within the network environment 500.

Beginning with block 600, the client application 529 can be executed to establish a connection with the terminal application 533. In some examples, the client application 529 and the terminal application 533 can establish a secure short-range wireless connection using near-field communication (NFC) technology supported on the client device 100 and the payment terminal 103. In other examples, the client application 529 and the terminal application 533 can establish a secure short-range wireless connection with Bluetooth®, Wi-Fi, ultra-wideband, etc. In some examples, establishing the connection comprises sending and/or receiving signals and verifying that the connection is permissible to both the client device 100 and the payment terminal 103.

Next, at block 603, the client application 529 can be executed to receive a payment request. The payment request can be representative of a request for payment for a transaction. In some examples, the payment request can be received from the payment terminal 103 after the connection has been established at block 600. The payment request can be an encrypted request and contain data such as merchant data 519, transaction data 523, or other data. In some examples, the payment request can include information about which payment methods 200 are supported by the payment terminal 103.

Moving to block 606, the client application 529 can be executed to send a request for a payment method 200. The client application 529 can determine one or more supported payment methods 200. The request for a payment method can be representative of an instruction to display the payment methods 200 on a user interface 106. In some examples, the client application 529 can cause a request for a selection and one or more payment methods 200 to be displayed on the user interface 106 of the client device 100.

At block 609, the client application 529 can be executed to receive a selection of a payment method 200. The selection of the payment method 200 can be received by a user interaction with the user interface 106 of the client device 100. In some examples, the client application 529 can receive the selection of the payment method 200 from the user interface 106 or from another system, service, or application in the network environment 500.

Moving to block 613, the client application 529 can be executed to generate a payment instruction. The payment instruction can be representative of an instruction or request to make a payment for the transaction using the selected payment method 200 from block 609. The client application 529 can generate the payment instruction based at least in part on having received the selection of the payment method 200 at block 609. The client application 529 can generate the payment instruction based at least in part on the payment request received at block 603. For example, the client application 529 can include the payment amount from the transaction data 523 and the merchant identifier from the merchant data 519 in the payment request to generate the payment instruction.

At block 616, the client application 529 can be executed to send the payment instruction to an institution application 509. The client application 529 can determine an institution application 509 associated with the payment method 200 selected at block 609. For example, if the user selected an account-to-account transfer from their demand deposit account at their financial institution, the client application 529 can determine a financial institution identifier based at least in part on the payment method 200 and identify the institution application 509 associated with the financial institution based at least in part on the financial institution identifier. The client application 529 can send the payment instruction generated at block 613 to the institution application 509 in response to having received the selection of the payment method 200 at block 609.

Next, at block 619, the client application 529 can be executed to receive a payment authorization. In some examples, the client application 529 can receive a payment authorization from the institution application 509 once the payment instruction has been processed and the payment has gone through. The payment authorization can be representative of a notification or confirmation that the payment has been processed. In some examples, the payment authorization can be received from the terminal application 533.

At block 623, the client application 529 can be executed to send a payment response. In some examples, where the client application 529 receives the payment authorization from the institution application 509, the client application 529 can send the payment response to the terminal application 533 to notify the merchant that the payment has been processed. In some examples, the client application 529 can send the payment response to the user interface 106 of the client device 100 to notify the user that the payment has been processed. After block 623, the flowchart of FIG. 6 can come to an end.

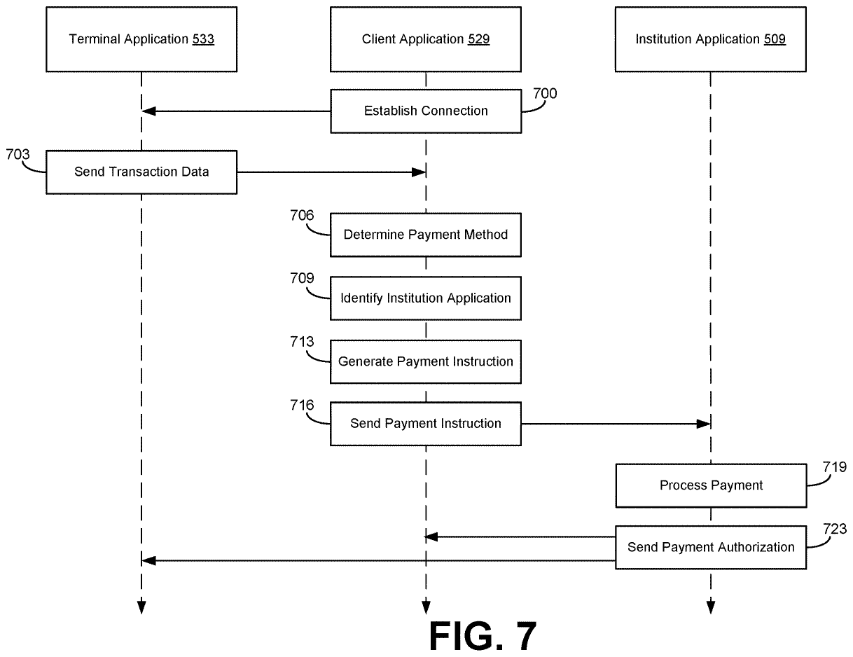

Referring next to FIG. 7, shown is a sequence diagram that provides one example of the operation of the interactions between the terminal application 533, the client application 529, and the institution application 509. The sequence diagram of FIG. 7 provides merely an example of the many different types of functional arrangements that can be employed to implement the operations of the depicted portions of the terminal application 533, the client application 529, and the institution application 509. As an alternative, the sequence diagram of FIG. 7 can be viewed as depicting an example of elements of a method implemented within the network environment 500.

Beginning with block 700, the client application 529 can be executed to establish a connection with the terminal application 533. In some examples, the client application 529 and the terminal application 533 can establish a secure short-range wireless connection using near-field communication (NFC) technology supported on the client device 100 and the payment terminal 103. In other examples, the client application 529 and the terminal application 533 can establish a secure short-range wireless connection with Bluetooth®, Wi-Fi, ultra-wideband, etc. In some examples, establishing the connection comprises sending and/or receiving signals and verifying that the connection is permissible to both the client device 100 and the payment terminal 103.

Next, at block 703, the terminal application 533 can be executed to send transaction data 523 to the client application 529. The terminal application 533 can be triggered to send the transaction data 523 to the client application 529 based at least in part on the establishment of the connection. In addition to transaction data 523, the terminal application 533 can send merchant data 519 or other data as well. This is in contrast to other payment protocols, where terminal application 533 would not send transaction data 523 to the client application 529 because the client application 529 could send payment information to the terminal application 533 for the terminal application 533 to authorize the transaction.

At block 706, the client application 529 can be executed to determine a payment method 200. In some examples, the client application 529 can send a request for a payment method 200 as described in the discussion of block 606 of FIG. 6 and receive a selection of a payment method 200 as described in the discussion of block 609 of FIG. 6. In some examples, the client application 529 can determine a payment method 200 based at least in part on a list of total supported payment methods 200 for the client device 100 and a list of total supported payment methods 200 received with the transaction data 523 from the terminal application 533. For example, the client application 529 can determine that only one payment method 200 is supported by both the client device 100 and the payment terminal 103 and select that payment method 200 for further processing.

At block 709, the client application 529 can be executed to identify an appropriate institution application 509. The client application 529 can determine an institution application 509 associated with the payment method 200 determined at block 706. For example, if the payment method 200 is an account-to-account transfer, the client application 529 can identify the account and the associated financial institution. Then, the client application 529 can identify the institution application 509 associated with the financial institution.

Next, at block 713, the client application 529 can be executed to generate a payment instruction. As described above, the payment instruction can be representative of an instruction or request to make a payment for the transaction using the determined payment method 200 from block 706. The client application 529 can generate the payment instruction based at least in part on having determined the payment method 200 at block 706 and/or having identified the institution application 509 at block 709. The client application 529 can generate the payment instruction based at least in part on the transaction data 523 received at block 703. For example, the client application 529 can include the payment amount from the transaction data 523 to generate the payment instruction.

At block 716, the client application 529 can be executed to send the payment instruction to the institution application 509 identified at block 709. For example, the client application 519 can make one or more calls to the API 513 to send the payment instruction to the institution application 509. In some examples, the client application 529 can send the transaction data 523 received at block 703 as well as merchant data 519 or other data along with the payment instruction.

The operations of blocks 709-716 can be performed in contrast to other payment protocols. For example, when making a payment using a mobile wallet on a mobile device using other payment protocols, a user could select a stored payment instrument (e.g., a stored credit card) and the mobile device could provide the stored payment instrument to the terminal application 533. The terminal application 533 could then send a transaction authorization request using a payment processing network (e.g., a debit card, credit card, or EFTPOS network). Accordingly, the client application 529 in these other protocols would not need to identify an institution application 509 to send a payment instruction to, generate the payment instruction, or send the payment instruction to the institution application 509 (e.g., by making one or more calls to the API 513).

Next, at block 719, the institution application 509 can be executed to process the payment. Based at least in part on the payment instruction received at block 716, the institution application 509 can identify the accounts involved in the payment as well as the amount to be transferred. In some instances, the institution application 509 can authenticate the user by sending a request for authentication to the user interface 106 of the client device 100. For example, the institution application 509 can send a request for a passcode or a biometric authentication to the user interface 106 of the client device 100 and receive an appropriate response from the user via the user interface 106. This is in contrast to other payment protocols, where the client device 100 might locally request a passcode or perform biometric authentication before providing payment account information to the terminal application 533 (e.g., stored debit or credit card information). The sending of an authentication request and receiving of an authentication response can constitute a portion of processing the payment. The institution application 509 can further accomplish the transferring of the funds from the user account to the merchant account. In some examples, the institution application 509 uses open banking rails to accomplish the transfer.

Next, at block 723, the institution application 509 can be executed to send a payment authorization. The payment authorization can be representative of a notification or confirmation that the payment has been processed. In some examples, the institution application 509 can send a payment authorization to the client application 529 once the payment instruction has been processed and the payment has gone through. In some examples, the payment authorization can be sent to the terminal application 533 after the payment has been processed.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 503.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor, a memory, and a display; and
machine-readable instructions stored in the memory that, when executed by the processor, cause the computing device to at least:
receive a payment request from a payment terminal;
send a request for payment method to a user interface presented on the display of the computing device;
receive a selection of a payment method via the user interface, the payment method comprising a transfer from an account;
generate a payment instruction based at least in part on the selection of the payment method;
send the payment instruction to an institution application associated with the account; and
receive a payment authorization from the institution application.

2. The system of claim 1, wherein the machine-readable instructions further cause the computing device to at least send a payment response to the payment terminal based at least in part on the payment authorization.

3. The system of claim 2, wherein the payment response includes at least the payment authorization and an authentication from the computing device.

4. The system of claim 1, wherein the machine-readable instructions further cause the computing device to at least:
establish a secure short-range wireless connection with the payment terminal; and
receive the payment request from the payment terminal via the secure short-range wireless connection.

5. The system of claim 1, wherein the machine-readable instructions further cause the computing device to at least:
receive merchant data and transaction data with the payment request; and
send the merchant data and the transaction data with the payment instruction.

6. The system of claim 1, wherein the machine-readable instructions further cause the computing device to at least:
send the payment instruction to the institution application via an application programming interface; and
receive the payment authorization from the institution application via the application programming interface.

7. The system of claim 1, wherein the machine-readable instructions which cause the computing device to generate the payment instruction, further cause the computing device to at least:
send an authentication request to the user interface;
receive an authentication response via the user interface; and
send the authentication response with the payment instruction.

8. A method, comprising:
receiving, by a computing device, a payment request from a payment terminal;
sending, by the computing device, a request for payment method to a user interface presented on the display of the computing device;
receiving, by the computing device, a selection of a payment method via the user interface, the payment method comprising an account;
generating, by the computing device, a payment instruction based at least in part on the selection of the payment method;
sending, by the computing device, the payment instruction to an institution application associated with the account; and
receiving, by the computing device, a payment authorization from the institution application.

9. The method of claim 8, further comprising sending, by the computing device, a payment response to the payment terminal based at least in part on the payment authorization.

10. The method of claim 9, wherein the payment response includes at least the payment authorization and an authentication from the computing device.

11. The method of claim 8, further comprising:
establishing, by the computing device, a secure short-range wireless connection with the payment terminal; and
receiving, by the computing device, the payment request from the payment terminal via the secure short-range wireless connection.

12. The method of claim 8, further comprising:
receiving, by the computing device, merchant data and transaction data with the payment request; and
sending, by the computing device, the merchant data and the transaction data with the payment instruction.

13. The method of claim 8, further comprising:
sending, by the computing device, the payment instruction to the institution application via an application programming interface; and
receiving, by the computing device, the payment authorization from the institution application via the application programming interface.

14. The method of claim 8, wherein generating the payment instruction, further comprises:
sending, by the computing device, an authentication request to the user interface;
receiving, by the computing device, an authentication response via the user interface; and
sending, by the computing device, the authentication response with the payment instruction.

15. A system, comprising:
a computing device comprising a processor and a memory; and
machine-readable instructions stored in the memory that, when executed by the processor, cause the computing device to at least:
establish a secure short-range connection with a payment terminal;
receive transaction data from the payment terminal via the secure short-range connection, the transaction data associated with a transaction;
determine a payment method for the transaction, the payment method comprising a transfer from an account;
identify an institution application associated with the account; and
send a payment authorization request to the institution application.

16. The system of claim 15, wherein the machine-readable instructions which cause the computing device to determine a payment method for the transaction, further cause the computing device to at least:
send a request for payment method to a user interface presented on the display of the computing device; and
receive a selection of the payment method via the user interface.

17. The system of claim 15, wherein the machine-readable instructions, when executed by the processor, further cause the computing device to at least:
generate a payment instruction based at least in part on the payment method; and
send the payment instruction to the institution application.

18. The system of claim 15, wherein the machine-readable instructions, when executed by the processor, further cause the computing device to at least:
receive a payment authorization from the institution application; and
send a payment response to the payment terminal includes at least the payment authorization and an authentication from the computing device.

19. The system of claim 15, wherein the machine-readable instructions, when executed by the processor, further cause the computing device to at least:
receive merchant data with the transaction; and
send the merchant data with the payment authorization request.

20. The system of claim 15, wherein the machine-readable instructions, when executed by the processor, further cause the computing device to at least:
authenticate a user associated with the account; and
send an authentication verification with the payment authorization.
